(19) United States
(12) Patent Application Publication
(10) Pub. No.: US 2022/0097318 A1
(43) Pub. Date: Mar. 31, 2022

(54) PRESSURIZING DEVICE, AND METHOD AND APPARATUS FOR MANUFACTURING FIBER REINFORCED RESIN PIPE USING PRESSURIZING DEVICE

(71) Applicant: Sumitomo Rubber Industries, Ltd., Hyogo (JP)

(72) Inventors: Masahide ONUKI, Kobe-shi (JP); Yumi KANEMITSU, Kobe-shi (JP); Ryota SAKAMINE, Kobe-shi (JP); Kazuyoshi SHIGA, Kobe-shi (JP)

(73) Assignee: Sumitomo Rubber Industries, Ltd., Hyogo (JP)

(21) Appl. No.: 17/464,254

(22) Filed: Sep. 1, 2021

(30) Foreign Application Priority Data
Sep. 29, 2020 (JP) 2020-163825

(51) Int. Cl. B29C 70/46; B29C 43/52; B29C 43/02; B29C 70/06; B29C 70/52

(52) U.S. Cl. CPC B29C 70/462; B29C 43/52; B29C 43/027; B29C 70/06; B29L 2023/22; B29C 2043/028; B29C 2791/002; B29C 2791/001; B29C 70/528

(57) ABSTRACT

A pressurizing device is used for manufacturing a fiber-reinforced resin pipe from a pipe-shaped laminate body prepreg sheets, and comprises a tubular main body. The tubular main body is provided with a helical cut extending helically in the axial direction so as to have a helical cut portion made of a metal. The helical cut portion is arranged inside or outside of the pipe-shaped laminate body. The helical cut portion changes its outer diameter and inner diameter to press the laminate body when a torsional moment and/or a force in the axial direction is applied thereto.

### TECHNICAL FIELD

The present disclosure relates to a pressurizing device used for manufacturing a fiber reinforced resin pipe, and a method and an apparatus for manufacturing a fiber reinforced resin pipe using the pressurizing device.

### BACKGROUND ART

In recent years, fiber reinforced resin pipes having high specific strength have been used for, for example, golf club shafts, shafts of various sports equipments, fishing rods, and the like.

As a method for producing a fiber reinforced resin pipe, a wrapping method and an internal pressure method are known (see, for example, Patent Documents 1 and 2 below).

In the wrapping method, first, prepreg sheets are wound in a predetermined number of layers around an iron mandrel to form a pipe-shaped laminate body.

Incidentally, the prepreg is a sheet of reinforcing fibers oriented in one direction or multiple directions and impregnated with an uncured resin.
Next, a resin wrapping tape is helically wound around the pipe-shaped laminate body, for example while applying a tension to the tape, and then heated in a curing furnace to cure the resin matrix of the prepreg sheets. Thereby, a pipe made of the fiber reinforced resin is manufactured.
By applying a tension to the wrapping tape, the tape functions to discharge the air entrapped between the prepreg sheets when laminated and the air existing in the melted resin matrix when cured, to the outside of the laminate body so that no voids are formed in the cured resin.

In the internal pressure method, first, a pipe-shaped laminate body is formed by winding a desired number of prepreg sheets around the outer peripheral surface of a heat-resistant resin tube, and the pipe-shaped laminate body is placed in cavity of a mold together with the heat-resistant resin tube. Then, the tube is expanded by supplying pressurized air so as to press the laminate body against the internal surface of the cavity so that the laminate body is shaped and the air in the laminate body is discharged.

Then, by heating the mold, the resin matrix is cured (see, Patent Document 2 below).
Patent Document 1: Japanese patent application publication No. H1-279932
Patent Document 2: Japanese patent application publication No. S51-23575

### SUMMARY OF THE DISCLOSURE

### Problems to be Solved by the Disclosure

In order to manufacture a high-quality fiber reinforced resin pipe, it is important to eliminate voids in the resin as much as possible. For that purpose, in the case of the wrapping method, it is necessary to strongly press the laminate body of the prepreg sheets against the mandrel.

In the case of the internal pressure method, it is necessary to strongly press the laminate body of the prepreg sheets against the internal surface of the cavity of the mold.

However, the resin wrapping tape used in the wrapping method and the resin tube used in the internal pressure method both have room for improvement in terms of the strength to press the laminate body against the mandrel and the mold.

The present disclosure has been devised in view of the above problems, and aims to provide a pressurizing device capable of more strongly pressing a prepreg laminate body, and a method and equipment for manufacturing a fiber reinforced resin pipe using the pressurizing device.

### Means for Solving the Problems

A first embodiment of the present disclosure is a pressurizing device which is used for manufacturing a fiber reinforced resin pipe from a laminate body in which prepreg sheets are laminated in a pipe shape, and which comprises:

a tubular main body having an outer diameter, an inner diameter, an axial center and an axial direction of the axial center, wherein

the tubular main body is provided with a helical cut extending helically in the axial direction so as to have a helical cut portion with a helical structure defined by the helical cut,

the helical cut portion is made of a metal, and arranged so as to positioned on an inner peripheral surface side of the laminate body, or alternatively an outer peripheral surface side of the laminate body, and

when a torsional moment around the axial center and/or a force in the axial direction is applied to the helical cut portion, the helical cut portion is deformable to change the outer diameter and the inner diameter in the helical cut portion.

A second embodiment of the present disclosure is a method for manufacturing the fiber-reinforced resin pipe using the pressurizing device, which comprises:

a laminating step of laminating the prepreg sheets on a mandrel to form the pipe-shaped laminate body;

a setting step of setting the helical cut portion of the pressurizing device so as to cover the outer peripheral surface of the laminate body; and

a pressurizing step of pressing the pipe-shaped laminate body toward the mandrel by reducing the above-said inner diameter in the helical cut portion.

A third embodiment of the present disclosure is a method for manufacturing the fiber-reinforced resin using the pressurizing device, which comprises:

a laminating step of laminating the prepreg sheets on an outer peripheral surface of the helical cut portion of the pressurizing device to form the pipe-shaped laminate body,

a setting step of setting the pipe-shaped laminate body in a cavity of a mold together with the pressurizing device, and

a pressurizing step of pressing the laminate body toward the internal surface of the cavity by increasing the above-said outer diameter in the helical cut portion.

A fourth embodiment of the present disclosure is an apparatus for manufacturing the fiber-reinforced resin pipe, which comprises: a mandrel; and the pressurizing device for pressing the pipe-shaped laminate body formed on the mandrel toward the mandrel.

A fifth embodiment of the present disclosure is an apparatus for manufacturing the fiber reinforced resin pipe, which comprises; the pressurizing device, on the outer peripheral surface of which the pipe-shaped laminate body is formed by laminating the prepreg sheets; and a mold having a cavity in which the laminate body is set together with the pressurizing device to shape the laminate body.

### EFFECTS OF THE INVENTION

According to the present disclosure, therefore, the pressurizing device can press the pipe-shaped laminate body of the prepreg sheets more strongly from the inside or outside of the pipe-shaped laminate body.

Further, the method and apparatus for manufacturing the fiber reinforced resin pipe according to the present disclosure, can press the pipe-shaped laminate body more strongly toward the mandrel and the mold.

### BRIEF DESCRIPTION OF THE DRAWINGS

FIG. 1 is a perspective view of a pressurizing device as an embodiment of the present disclosure.

FIG. 2 is a side view of the pressurizing device.

FIG. 3 is an enlarged side view showing a part of the helical cut portion of the pressurizing device.

FIGS. 4A and 4B are diagrams for explaining deformed states of the helical cut portion shown in FIG. 3.

FIG. 5 is a perspective view of a manufacturing apparatus according to an embodiment 1 of the present disclosure.

FIG. 6 is a perspective view of the pressurizing device for explaining a pressurizing step of the embodiment 1.

FIG. 7 is a perspective view of a manufacturing apparatus according to an embodiment 2 of the present disclosure.

FIG. 8 is a cross-sectional partial view of the pressurizing device for explaining the laminating step of the embodiment 2.

FIG. 9 is a cross-sectional partial view for explaining the setting step of the embodiment 2.

FIG. 10 is a cross-sectional partial view for explaining the pressurizing step of the embodiment 2.

FIG. 11 is a side view of the pressurizing device as another embodiment of the present disclosure.

FIG. 12 is a partial side view of the pressurizing device as still another embodiment of the present disclosure.

FIG. 13 is a partial side view of the pressurizing device as yet still another embodiment of the present disclosure.

FIG. 14A and FIG. 14B are cross-sectional views of the pressurizing device as yet still another embodiment of the present disclosure taken at positions corresponding to lines I-I and II-II of FIG. 2.

### DETAILED DESCRIPTION OF THE DISCLOSURE

Embodiments of the present disclosure will now be described in detail in conjunction with accompanying drawings.

### [Pressurizing Jig ]

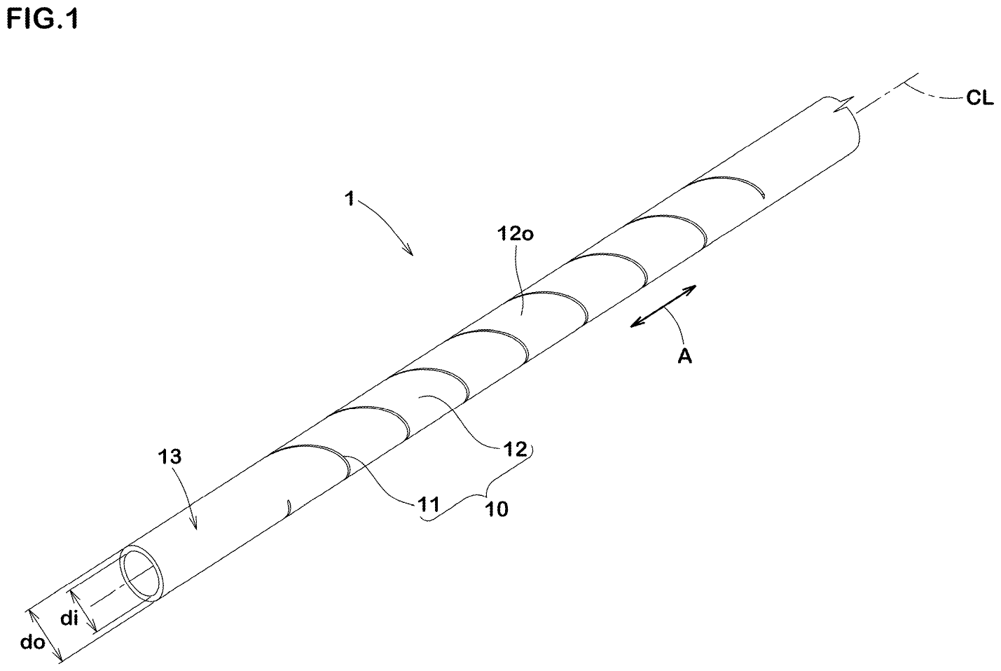

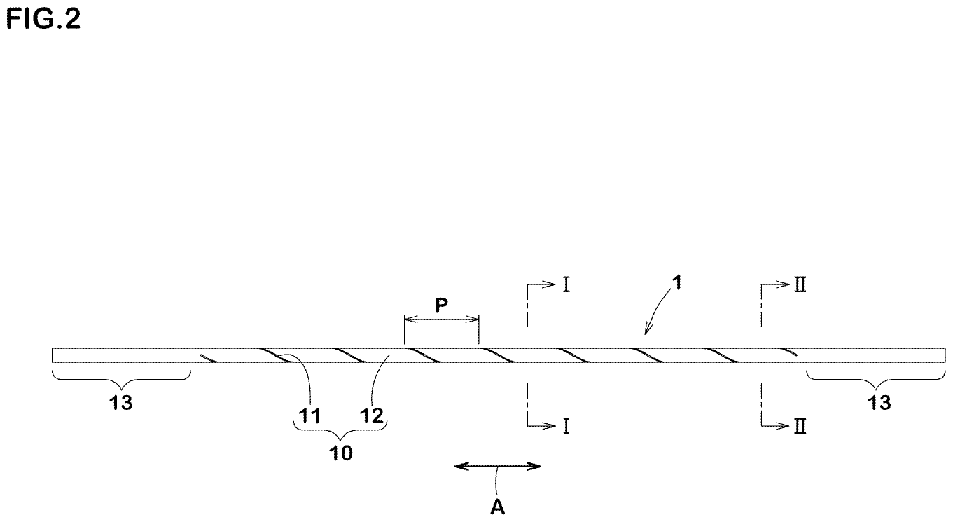

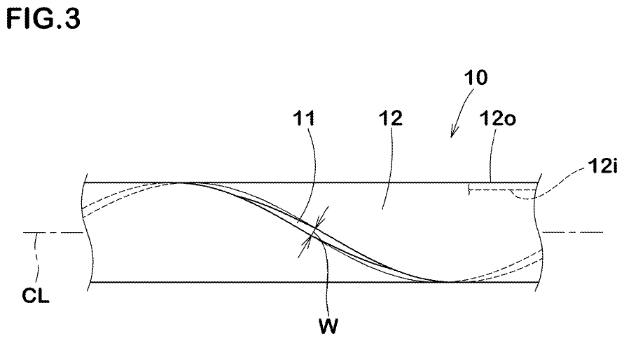

FIG. 1 is a perspective view of a pressurizing device 1 as a first embodiment of the present disclosure. FIG. 2 is a side view thereof, and FIG. 3 is an enlarged partial side view thereof.

The pressurizing device 1 is used to manufacture a pipe made of fiber reinforced resin by laminating prepreg sheets in a pipe shape.

The pressurizing device 1 comprises a tubular main body 10.

The tubular main body 10 has an outer diameter “do”, an inner diameter “di”, an axial center “CL”, and the direction “A” of the axial center.

The tubular main body 10 is provided with a helical cut 11 extending helically in the axial direction “A” to helically cut a portion of the tubular main body 10 into a helical cut portion 12 having a helical structure.

Specifically, the helical cut 11 penetrates the wall of the tubular main body 10 as shown in FIG. 3.

The helical cut 11 has a width W in the direction perpendicular to the helically extending direction (axial direction “A”) at the outer peripheral surface 12o.

In the example shown in FIGS. 1 to 3, the helical cut 11 has a right-handed helical orientation in which the helical is clockwise when the helix advances to the left side of the figures. As another example, the helical cut 11 may have a left-handed helical orientation opposite to that of FIGS. 1 to 3.

In this example, the helical pitch P (shown in FIG. 2) in the axial direction “A”, of the helical cut 11 is constant along the axial direction “A”. As other example, the helical cut 11 may have a variable helical pitch P in the axial direction “A” as described later.

In this embodiment, the tubular main body 10 is made of a metal material. Accordingly, the helical cut portion 12 is made of the metal material. As the metal material constituting the helical cut portion 12, various metal materials, e.g. carbon steel, stainless steel and the like can be used.

The outer diameter “do” and the inner diameter “di” in the helical cut portion 12 of the tubular main body 10 are defined by the outer peripheral surface 12o and the inner peripheral surface 12i of the helical cut portion 12, respectively.

The outer diameter “do” is determined so as to be able to dispose the helical cut portion 12 on the inner peripheral surface side of the pipe-shaped laminate body made of the prepreg sheets to be pressurized, or

the inner diameter “di” is determined so as to be able to dispose the helical cut portion 12 on the outer peripheral surface side of the pipe-shaped laminate body made of the prepreg sheets to be pressurized, depending on how the pressurizing device 1 is used (explained later).

In the pressurizing device 1 in the present embodiment, as shown in FIG. 2, each or one of axial end portions of the tubular main body 10 may be provided with an handling portion 13 where the cut 11 is not formed.

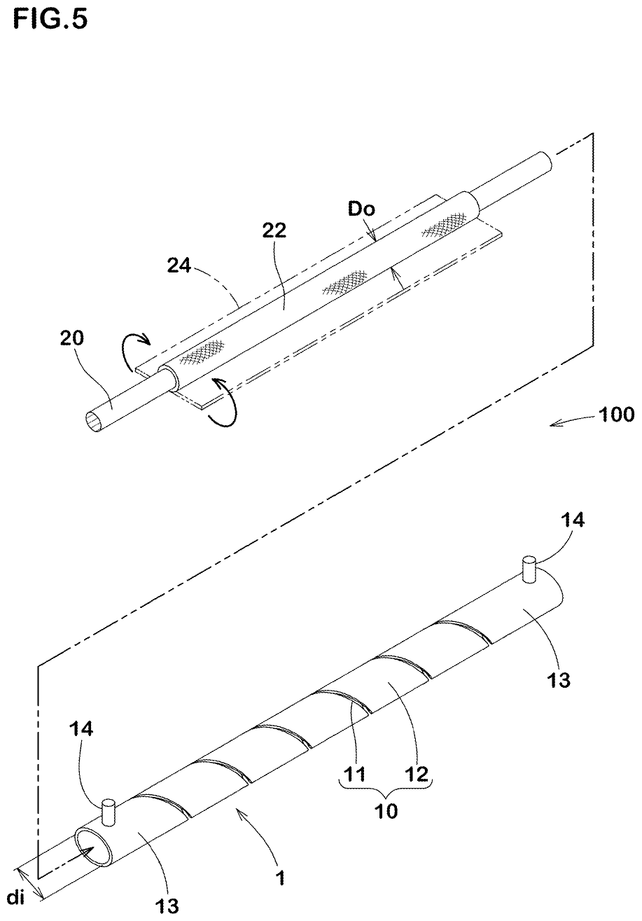

In order to twist the helical cut portion 12 about the axial center “CL”, the handling portion 13 is utilized to connect to various actuators for example.
Further, as shown in FIG. 5, the handling portion 13 may be provided with, for example, a lever 14 or the like for twisting the helical cut portion 12.

Next, the working of the pressurizing device 1 in the present embodiment will be described.

when the helical cut portion 12 receives a torsional moment around the axial center “CL” and/or a force (tensile force or compressive force) in the axial direction “A”, then the outer diameter “do” and the inner diameter “di” thereof are varied.

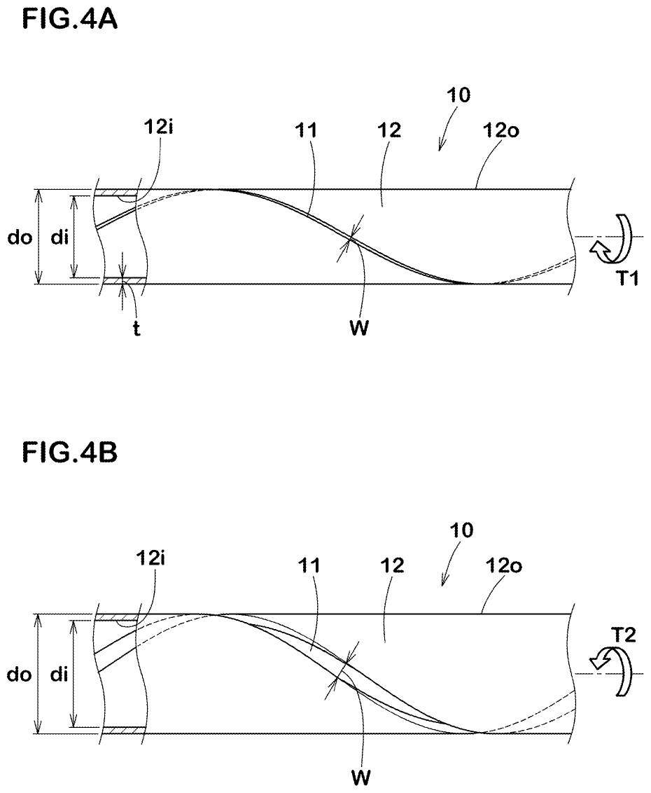

FIG. 4A and FIG. 4B are for explaining the deformation of the helical cut portion 12 by the torsional moment and the tensile and compressive forces.

FIG. 4A shows an example of a deformed state of the helical cut portion 12 when a torsional moment T1 is applied thereto.

In this example, the torsional moment T1 has a twisting direction to reduce the width W of the helical cut 11. When the width W of the helical cut 11 is reduced by such torsional moment T1, the outer diameter “do” and the inner diameter “di” become smaller than those in the nondeformed state shown in FIG. 3.

Further, such a deformed state can also be obtained by applying a tensile force in the axial direction “A” to the helical cut portion 12 instead of the torsional moment T1. In this case, while the helical cut portion 12 getting elongated, the outer diameter “do” and the inner diameter “di” of the helical cut portion 12 become smaller than those in the nondeformed state shown in FIG. 3.

FIG. 4B shows an example of a deformed state of the helical cut portion 12 when a torsional moment T2 is applied thereto. In this example, the torsional moment T2 has a twisting direction to increase the width W of the helical cut 11, which is opposite to the twisting direction of the torsional moment T1 in the above-described example.

When the width W of the helical cut 11 is increased by such torsional moment T2, the outer diameter “do” and the inner diameter “di” become larger than those in the nondeformed state shown in FIG. 3.

Further, such a deformed state can also be obtained by applying a compressive force in the axial direction “A” to the helical cut portion 12 instead of the torsional moment T2. In this case, while reducing the width W of the helical cut 11, the outer diameter “do” and the inner diameter “di” of the helical cut portion 12 become larger than those in the nondeformed state shown in FIG. 3.

The pressurizing device 1 can be used to press the pipe-shaped laminate body of the prepreg sheets from the outer peripheral surface side thereof by decreasing the outer diameter “do” and the inner diameter “di” of the helical cut portion 12 disposed outside the laminate body

or
from the inner peripheral surface side thereof by increasing the outer diameter “do” and the inner diameter “di” of the helical cut portion 12 disposed inside the laminate body.

Further, as the helical cut portion 12 is made of the metal material, the pressurizing device 1 can press the pipe-shaped laminate body more strongly as compared with the conventional wrapping tape and the resin tube.

Further, in the tubular main body 10 in the present embodiment, by changing the magnitude of the torsional moment T1 and T2 (or magnitude of torque), the outer diameter “do” and the inner diameter “di” can be changed. Therefore, the pressing force to the pipe-shaped laminate body can be easily adjusted. By increasing the width W of the helical cut 11, the diameter change of the helical cut portion 12 may be increased.

Next, specific embodiments of a method and an apparatus for manufacturing the fiber reinforced resin pipe using the pressurizing device 1 will be described.

### Embodiment 1 of Manufacturing Method and Manufacturing Apparatus

FIG. 5 shows an apparatus 100 for manufacturing a pipe made of fiber reinforced resin according to an embodiment 1.

The manufacturing apparatus 100 in the embodiment 1 comprises the pressurizing device 1 and a mandrel 20.
The mandrel 20 in this example is a metal cylindrical shaft.

In the manufacturing method in the embodiment 1, firstly performed is a laminating step of laminating prepreg sheets on the mandrel 20 to form a pipe-shaped laminate body 22.

The configurations of the prepreg seats are determined according to the pipe to be manufactured (for example, a golf club shaft or the like).

Next, performed is a setting step of setting the helical cut portion 12 of the pressurizing device 1 on the outer peripheral surface side of the laminate body 22.

In the present embodiment, in the stress free state of the pressurizing device 1 where no external force acts on the pressurizing device 1,
the inner diameter “di” of the helical cut portion 12 is larger than the outer diameter “Do” of the laminate body 22 formed on the mandrel 20.

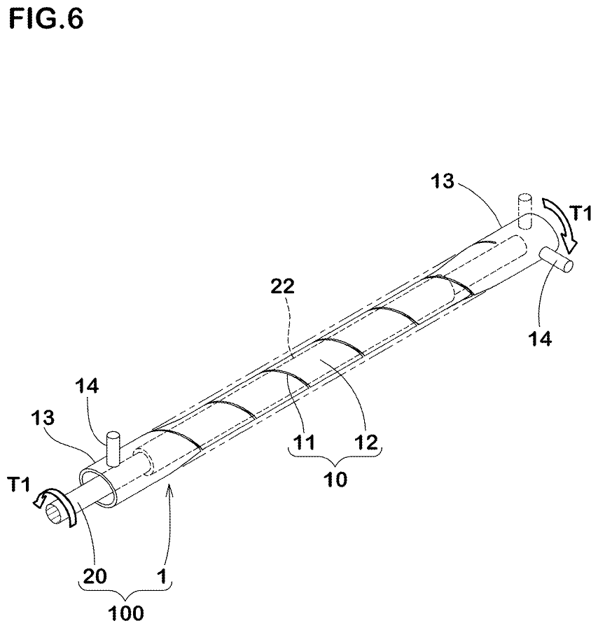

Next, as shown in FIG. 6, a torsional moment T1 is applied to the helical cut portion 12, and thereby the inner diameter “di” of the helical cut portion 12 is reduced. Therefore, the inner peripheral surface 12i of the helical cut portion 12 of which inner diameter “di” is decreased on the outer peripheral surface side of the laminate body 22, is brought into contact with the outer peripheral surface of the laminate body 22, and presses the laminate body 22 toward the mandrel 20.

As a result, the air between the prepreg sheets of the laminate body 22 is discharged to the outside, for example, and the air bubbles remained in the resin are pressurized and become extremely small.
Thus, in the embodiment 1, the inner peripheral surface 12i of the helical cut portion 12 is used as a pressure surface for pressing the laminate body 22 toward its axial center.

In the present embodiment, the torsional moment T1 is given to the helical cut portion 12 after the setting step in order to decrease the inner diameter “di” of the helical cut portion 12.

However, it is also possible as another example that a torsional moment T2 opposite direction is given to the helical cut portion 12 to increase the inner diameter “di”, and then the helical cut portion 12 in such expanded state is set on the outer peripheral surface side of the laminate body 22.

Then, after the setting, the helical cut portion 12 is released from the torsional moment T2 to allow the helical cut portion 12 to return to its original state so that the increased inner diameter is decreased to the original inner diameter “di”, and thereby the laminate body 22 is pressed toward its axial center by using such a restoring (shrink) force.
In this case, the inner diameter “di” of the helical cut portion 12 in the above-mentioned stress free state is set to be smaller than the outer diameter of the laminate body 22.

Next, a heating step is performed in order to heat the laminate body 22 by putting it in a curing furnace or the like. Preferably, the heating step is performed under such a condition that the laminate body 22 is pressed by the helical cut portion 12. That is, the mandrel 20 and the laminate body 22 thereon are put in the curing furnace together with the pressurizing device 1 while the laminate body 22 is being pressed by the helical cut portion 12.

As a result, the resin matrix of the laminate body 22 melts by the heat energy while receiving a stronger pressing force from the pressurizing device 1, and the air existing in the resin can be effectively discharged to the outside. Thus, the pipe with few voids can be manufactured.

After the heating step is completed, the torsional moment T1 applied to the pressurizing device 1 is removed. Thereby, the helical cut portion 12 returns to the original state while increasing the inner diameter to the original “di”. Thus, the pressurizing device 1 can be easily removed from the formed pipe by moving it in the axial direction “A”.

Preferably, the manufacturing method further comprises, after the laminating step and before the setting step, a step of forming a barrier layer 24 (shown in FIG. 5) for preventing the laminate body 22 from coming into direct contact with the helical cut portion 12.

The formation of such barrier layer 24 is also preferred for preventing the molten resin from flowing out through the helical cut 11 of the helical cut portion 12 during the heating step.

Such barrier layer 24 can be formed by winding a single sheet on the laminate body 22 in a pipe shape, for example, as shown in FIG. 5.

On the other hand, the barrier layer 24 can be formed from a tape wound helically around the laminate body 22 a plurality of times without gaps (not shown).
Further, the barrier layer 24 can be formed by a resin tube (not shown) disposed to surround the laminate body.
Such barrier layer 24 is not intended to press the laminate body 22, therefore, high strength is not required. It suffices to have heat resistance being able to withstand the high temperature during the heating step.
Therefore, various materials such as a resin sheet, a metal sheet, and a fiber sheet can be used for the barrier layer 24.

### Embodiment 2 of Manufacturing Method and Apparatus

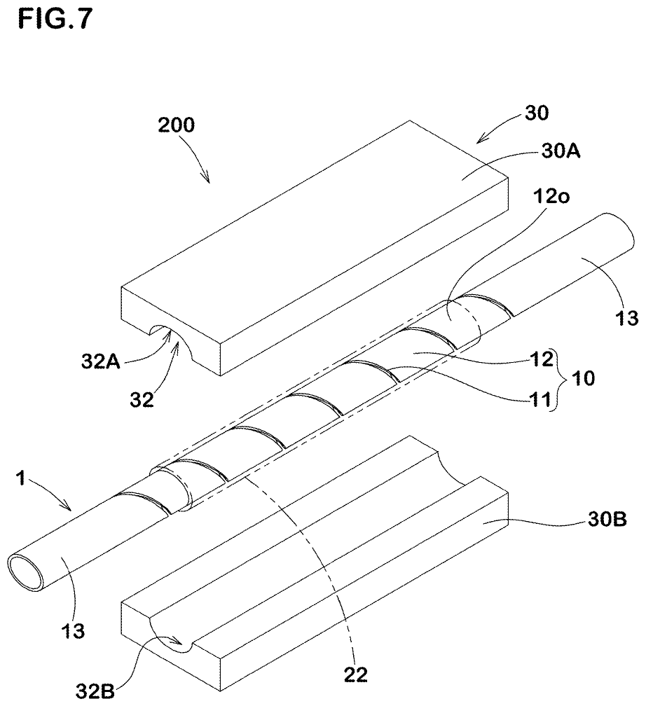

FIG. 7 shows an apparatus 200 for manufacturing the fiber reinforced resin pipe according to an embodiment 2.

The manufacturing apparatus 200 of the embodiment 2 comprises the pressurizing device 1 and a mold 30 having a cavity 32.

In the embodiment 2, the pressurizing device 1 is used as a mandrel, and

on the outer peripheral surface 12o of helical cut portion 12, prepreg sheets are wound and laminated to form the pipe-shaped laminate body 22.

The mold 30 comprises, for example, an upper mold 30A and a lower mold 30B. The upper mold 30A and the lower mold 30B are respectively provided with an upper cavity 32A and an lower cavity 32B, for example.

By closing the upper mold 30A and the lower mold 30B, the upper cavity 32A and the lower cavity 32B form the cavity 32 for shaping the outer peripheral surface of the pipe to be manufactured.
In this example, the cavity 32 has a cylindrical shape, and the inner diameter of the cavity 32 is larger than the outer diameter of the laminate body 22 wound on the helical cut portion 12.
Therefore, the helical cut portion 12 around which the laminate body 22 is formed can be set in the cavity 32.

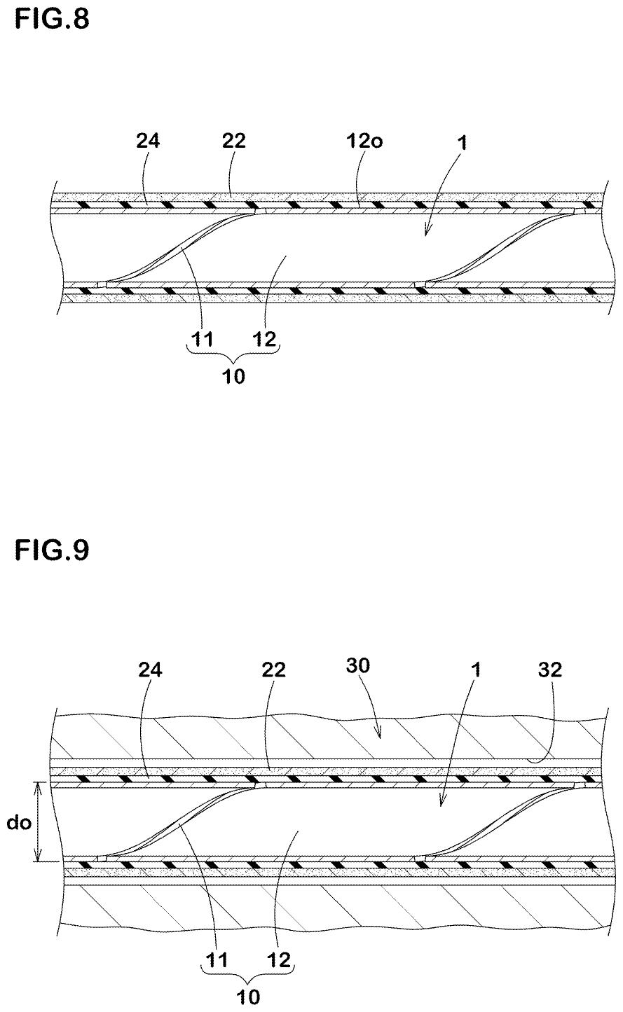

In the manufacturing method of the embodiment 2, first, a laminating step is performed in which, as shown in FIGS. 7 and 8, the pipe-shaped laminate body 22 is formed by winding and laminating prepreg sheets on the outer peripheral surface 12o of the helical cut portion 12 of the pressurizing device 1.

Next, performed is a step of setting the laminate body 22 in the cavity 32 of the mold 30 together with the pressurizing device 1 as shown in FIG. 9. In this state, it is preferred that the above-mentioned handling portion 13 of the pressurizing device 1 protrudes from the mold 30 toward the outside thereof.

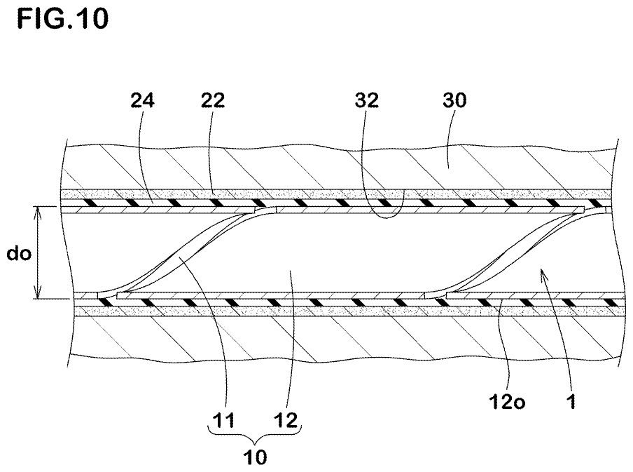

Next, a pressurizing step is performed in which, as shown in FIG. 10, the outer diameter “do” of the helical cut portion 12 placed in the cavity 32 is increased to press the laminate body 22 toward the inner surface of the cavity 32 for shaping. That is, in the embodiment 2, the helical cut portion 12 is placed on the inner peripheral surface side of the laminate body 22, and a torsional moment T2 is given so that the outer diameter “do” of the helical cut portion 12 is increased as shown in FIG. 4B.

The torsional moment can be easily given by using the handling portion 13 located outside the mold 30.

As described above, the outer peripheral surface 12o of the helical cut portion 12 can press the inner peripheral surface of the laminate body 22.

Thus, in the embodiment 2, the outer peripheral surface 12o of the helical cut portion 12 is used as a pressure surface for pressing the laminate body 22.

In order to heat the laminate body 22, the mold 30 is heated (heating step) before or after the pressurizing step. In the embodiment 2, it is desirable that at least a part of the heating step is performed in a state where the laminate body 22 is being pressed by the helical cut portion 12.

As a result, the resin matrix of the laminate body 22 melts by the heat energy while receiving a stronger pressing force from the pressurizing device 1, and the air existing in the resin can be effectively discharged to the outside. Thus, the pipe with few voids can be manufactured.

The mold 30 can be provided with vent holes, vent grooves and the like (not shown) through which the air in the mold 30 can be discharged to the outside of the mold.

After the heating step is completed, the torsional moment T2 applied to the pressurizing device 1 is removed. Thereby, the outer diameter of the helical cut portion 12 is decreased to the original outer diameter “do”.

Thus, the pressurizing device 1 can be easily removed from the formed pipe by moving it in the axial direction “A”.

Preferably, the manufacturing method of the embodiment 2 further comprises, before the lamination step, a step of forming the barrier layer 24 for preventing the laminate body 22 from coming into direct contact with the helical cut portion 12.

The barrier layer 24 prevents the molten resin of the laminate body 22 from flowing out through the helical cut 11 of the helical cut portion 12 during the heating step.
As the barrier layer 24, various examples as described in the embodiment 1 can be adopted.

### Other Embodiments of Pressurizing Jig

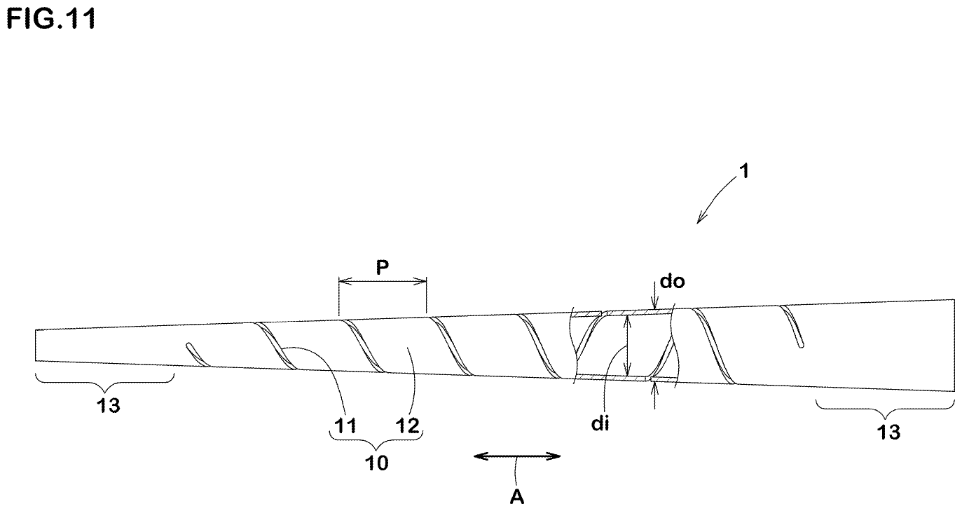

FIGS. 11 to 14 show other embodiments of the pressurizing device 1. These embodiments can be used in the above-described embodiments 1 and 2.

When manufacturing a fiber reinforced resin pipe having a constant outer diameter or inner diameter, the helical cut portion 12 has the outer diameter “do” and the inner diameter “di” which are constant in the axial direction “A” as shown in FIG. 2, for example.

### Embodiment of FIG. 11

When manufacturing a fiber reinforced resin pipe whose diameter changes in a tapered manner such as a golf club shaft, the helical cut portion 12 has the outer diameter “do” and the inner diameter “di” which becomes smaller toward one side in the axial direction “A” as shown in FIG. 11.

The helical cut portion 12 of the pressurizing device 1 according to the present disclosure is formed by a strip-shaped element 12a which is cut by the helical cut 11 and extends helically in the axial direction “A”.

The strip-shaped element 12a has a width L measured along the axial direction “A”, and a thickness t (shown in FIG. 4A) in the radial direction orthogonal to the axial direction “A”. Incidentally, the width L corresponds to the helical pitch P minus the width W of the helical cut 11.

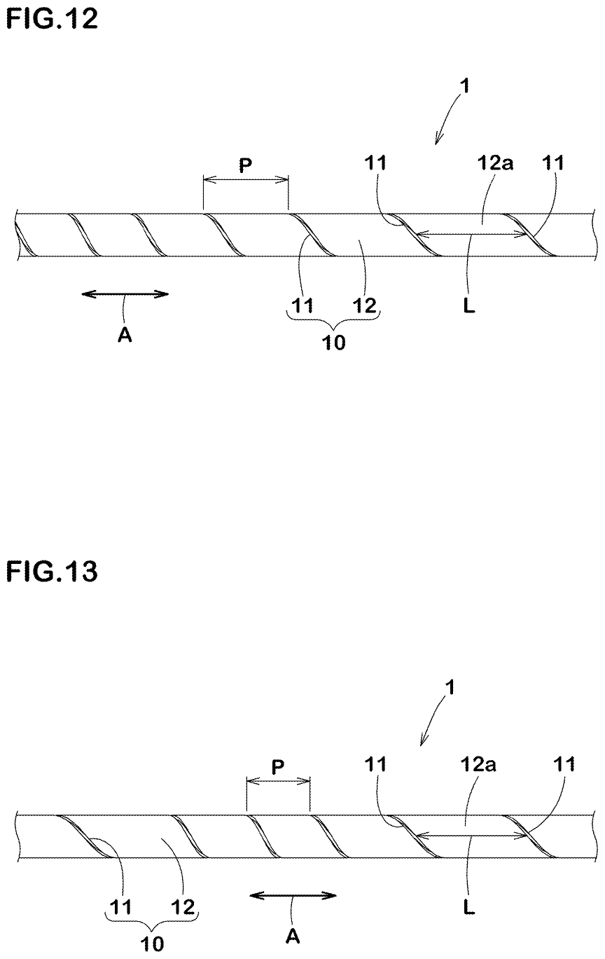

### Embodiment of FIG. 12

FIG. 12 is a schematic side view of the helical cut portion 12 in another embodiment.

In this embodiment, the bending rigidity around the axial center “CL”, of the strip-shaped element 12a is changed along the axial center direction “A”.
The bending rigidity of the strip-shaped element 12a can be changed by changing the width L and/or the thickness t of the strip-shaped element 12a.
In the embodiment of FIG. 12, the width L of the strip-shaped element 12a is gradually increased toward one side (right side in FIG. 12) of the axial direction “A” of the tubular main body 10.

In this embodiment, the width L is increased by increasing the helical pitch P toward the one side of the axial direction “A” while keeping the width W of the helical cut 11 constant. Further, the thickness t is constant along the axial direction “A”. Therefore, the bending rigidity of the strip-shaped element 12a increases toward the one side (right side in FIG. 12).

By using such embodiment, the pressing of the laminate body 22 advances toward the one side of the helical cut portion 12 in FIG. 12.

Namely, when a torsional moment is applied between both ends of the helical cut portion 12, as the bending moment acting on any position of the helical cut portion 12 is uniform along the axial direction “A”, deformation of the helical cut portion 12 starts from a position where the bending rigidity is lower (a part of the element located on the left side of FIG. 12). Then, when the position of the strip-shaped element 12a which has started this deformation comes into contact with the laminate body 22, and the pressing force balances with the resistance force from the laminate body 22, therefore, the deformation of this position is stopped.
Nevertheless, the torque is sequentially-transmitted to positions on the right side of the strip-shaped element 12a where the pressing force is not yet balanced with the resistance force from the laminate body 22, therefore, the deformation and the pressing thereby progress toward the right side of FIG. 12.

In this embodiment, as described above, as the deformation of the strip-shaped element 12a starts from the left side of FIG. 12 and progresses to the right side, the sliding between the helical cut portion 12 and the laminate body 22 during pressing becomes smooth.

Such embodiment is particularly useful when manufacturing a tapered pipe, in which the pressure is preferably applied to the laminate body 22 from the small diameter side to the large diameter side. Further, such embodiment is particularly useful in that the molten resin of the laminate body 22 can be squeezed out toward one side in the axial direction “A”.

### Embodiment of FIG. 13

FIG. 13 shows still another embodiment of the helical cut portion 12. In this embodiment, the bending rigidity of the strip-shaped element 12a increases toward both sides in the axial direction “A” from a mid position.

For that purpose, the width L of the strip-shaped element 12a is increased toward both sides in the axial direction “A” from the mid position.
In such embodiment, the deformation of the strip-shaped element 12a starts from the mid position (central part of FIG. 13) and progresses toward both sides in the axial direction “A”.
Therefore, the sliding between the helical cut portion 12 and the laminate body 22 during pressing becomes smooth as in the embodiment of FIG. 12.
Such embodiment is useful when manufacturing a pipe whose outer diameter and inner diameter are constant.
Further, such embodiment is useful in that the molten resin of the laminate body 22 can be squeezed out toward both sides in the axial direction “A”.

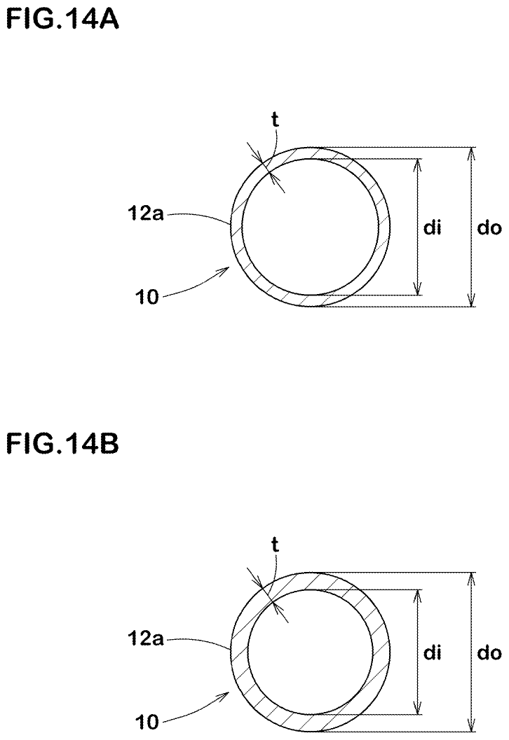

### Embodiment of FIG. 14

FIGS. 14A and 14B show cross-sectional views of the helical cut portion 12 of still another embodiment taken at positions corresponding to line I-I and line II-II of FIG. 2, respectively. In this embodiment, in order to change the bending rigidity of the strip-shaped element 12a along the axial direction “A”, the thickness t of the strip-shaped element 12a is changed along the axial direction “A”.

In this embodiment, the thickness t of the strip-shaped element 12a is increased toward one side in the axial direction “A”, of the tubular main body 10.
In this example, while keeping the width L of the strip-shaped element 12a constant, the thickness t is increased toward one side in the axial direction “A”, therefore, the bending rigidity of the strip-shaped element 12a is high at the position shown in FIG. 14B than the position shown in FIG. 14A.
In such embodiment, the same effect as that of the embodiment of FIG. 12 may be obtained.

Further, the thickness t of the strip-shaped element 12a may be increased toward both sides in the axial direction “A”, of the tubular main body 10 (not shown).

In such embodiment, the same effect as that of the embodiment of FIG. 13 may be obtained.

While detailed description has been made of preferable embodiments of the present disclosure, the present disclosure can be embodied in various forms without being limited to the illustrated embodiments. Further, as long as the fiber reinforced resin is manufactured using prepreg sheets, configurations, use and the like of the pipe are not limited.

### WORKING EXAMPLE

The pressurizing device shown in FIG. 1 was experimentally manufactured. In the stress free state of the pressurizing device, the inner diameter “di” was 11.9 mm, and the outer diameter “do” was 13.1 mm.

As the tubular main body 10, a stainless steel pipe was used, and the helical cut 11 was formed by laser beam machining. The width W of the helical cut 11 was about 1 mm, and the width L of the strip-shaped element was about 18 mm.
When torsional moments T1 and T2 were applied to the pressurizing device so that the torsional angles became 90 degrees, the outer diameter of the helical cut portion 12 of the pressurizing device was decreased by about 0.6 mm and increased by about 0.6 mm, respectively.

Preferred use targets of this pressurizing device are a pipe having an outer diameter of about 11.5 mm or less in the case of the first embodiment, and

a pipe having an inner diameter of about 13.5 mm or more in the case of the second embodiment.

### STATEMENT OF THE PRESENT DISCLOSURE

The present disclosure is as follows:

Disclosure 1: A pressurizing device which is used for manufacturing a fiber-reinforced resin pipe from a laminate body in which prepreg sheets are laminated in a pipe shape, and which comprises: a tubular main body having an outer diameter, an inner diameter, an axial center and an axial direction of the axial center, wherein

the tubular main body is provided with a helical cut extending helically in the axial direction so as to have a helical cut portion with a helical structure defined by the helical cut,

the helical cut portion is made of a metal, and arranged so as to positioned on an inner peripheral surface side of the laminate body, or alternatively an outer peripheral surface side of the laminate body, and

when a torsional moment around the axial center and/or a force in the axial direction is applied to the helical cut portion, the helical cut portion is deformable to change the outer diameter and the inner diameter in the helical cut portion.

Disclosure 2: The pressurizing device according to Disclosure 1, wherein the helical cut portion has an inner peripheral surface which defines said inner diameter and which is a pressure surface for pressing the outer peripheral surface of the laminate body.

Disclosure 3: The pressurizing device according to Disclosure 1, wherein the helical cut portion has an outer peripheral surface which defines the said outer diameter and which is a pressure surface for pressing the inner peripheral surface of the laminate body.

Disclosure 4: The pressurizing device according to Disclosure 1, 2 or 3, wherein the helical cut portion extends in the axial direction in a tapered manner.

Disclosure 5: The pressurizing device according to Disclosure 1, 2, 3 or 4, wherein the helical cut portion is formed from a strip-shaped element extending helically in the axial direction, and the bending rigidity around the axial center, of the strip-shaped element is changed in the axial direction.

Disclosure 6: The pressurizing device according to Disclosure 5, wherein the bending rigidity of the strip-shaped element is increased toward only one side in the axial direction of the tubular main body of the pressurizing device.

Disclosure 7: The pressurizing device according to Disclosure 5, wherein the bending rigidity of the strip-shaped element is increased toward both sides in the axial direction of the tubular main body of the pressurizing device.

Disclosure 8: A method for manufacturing the fiber-reinforced resin pipe using the pressurizing device according to any one of Disclosures 1, 2 and 4 to 7, which comprises:

a laminating step of laminating the prepreg sheets on a mandrel to form the pipe-shaped laminate body;

a setting step of setting the helical cut portion of the pressurizing device so as to cover the outer peripheral surface of the laminate body; and

a pressurizing step of pressing the pipe-shaped laminate body toward the mandrel by reducing said inner diameter in the helical cut portion.

Disclosure 9: The method according to Disclosure 8, which further comprises a heating step of heating the laminate body while the laminate body is pressed by the helical cut portion.

Disclosure 10: The method according to Disclosure 8 or 9, which further comprises, after the laminating step and before the setting step, a step of forming a barrier layer for preventing the laminate body from coming into direct contact with the helical cut portion.

Disclosure 11: A method for manufacturing the fiber-reinforced resin pipe using the pressurizing device according to any one of Disclosures 1 and 3 to 7, which comprises:

a laminating step of laminating the prepreg sheets on an outer peripheral surface of the helical cut portion of the pressurizing device to form the pipe-shaped laminate body;

a setting step of setting the pipe-shaped laminate body in a cavity of a mold together with the pressurizing device; and

a pressurizing step of pressing the laminate body toward the internal surface of the cavity by increasing said outer diameter in the helical cut portion.

Disclosure 12: The method according to Disclosure 11, which further comprises a heating step of heating the laminate body while the laminate body is pressed by the helical cut portion.

Disclosure 13: The method according to Disclosure 11 or 12, which further comprises, before the laminating step, a step of forming a barrier layer for preventing the laminate body from coming into direct contact with the helical cut portion.

Disclosure 14: The method according to Disclosure 10 or 13, wherein the barrier layer is a single sheet which is wound in a pipe shape.

Disclosure 15: The method according to Disclosure 10 or 13, wherein the barrier layer is a tape helically which is wound a plurality of times.

Disclosure 16: The method according to Disclosure 10 or 13, wherein the barrier layer is a resin tube.

Disclosure 17: An apparatus for manufacturing the fiber-reinforced resin pipe, which comprises: a mandrel; and the pressurizing device according to any one of Disclosures 1 to 7 for pressing the pipe-shaped laminate body formed on the mandrel toward the mandrel.

Disclosure 18: An apparatus for manufacturing the fiber reinforced resin pipe, which comprises:

the pressurizing device according to any one of Disclosures 1 to 7, on the outer peripheral surface of which the pipe-shaped laminate body is formed by laminating the prepreg sheets; and

a mold having a cavity in which the laminate body is set together with the pressurizing device to shape the laminate body.

### DESCRIPTION OF THE REFERENCE SIGNS

1 pressurizing device

10 tubular main body 10

11 helical cut

12 helical cut portion

12a strip-shaped element

12i inner peripheral surface

12o outer peripheral surface

20 mandrel

22 laminate body

24 barrier layer

30 mold

32 cavity

100 manufacturing apparatus

200 manufacturing apparatus

A axial direction

CL axial center

di inner diameter

do outer diameter

1. A pressurizing device which is used for manufacturing a fiber-reinforced resin pipe from a laminate body in which prepreg sheets are laminated in a pipe shape, and which comprises: a tubular main body having an outer diameter, an inner diameter, an axial center and an axial direction of the axial center, wherein
the tubular main body is provided with a helical cut extending helically in the axial direction so as to have a helical cut portion with a helical structure defined by the helical cut,
the helical cut portion is made of a metal, and arranged so as to positioned on an inner peripheral surface side of the laminate body, or alternatively an outer peripheral surface side of the laminate body, and
when a torsional moment around the axial center and/or a force in the axial direction is applied to the helical cut portion, the helical cut portion is deformable to change the outer diameter and the inner diameter in the helical cut portion.

2. The pressurizing device according to claim 1, wherein the helical cut portion has an inner peripheral surface which defines said inner diameter and which is a pressure surface for pressing the outer peripheral surface of the laminate body.

3. The pressurizing device according to claim 1, wherein the helical cut portion has an outer peripheral surface which defines the said outer diameter and which is a pressure surface for pressing the inner peripheral surface of the laminate body.

4. The pressurizing device according to claim 1, wherein the helical cut portion extends in the axial direction in a tapered manner.

5. The pressurizing device according to claim 1, wherein the helical cut portion is formed from a strip-shaped element extending helically in the axial direction, and the bending rigidity around the axial center, of the strip-shaped element is changed in the axial direction.

6. The pressurizing device according to claim 5, wherein the bending rigidity of the strip-shaped element is increased toward only one side in the axial direction of the tubular main body of the pressurizing device.

7. The pressurizing device according to claim 5, wherein the bending rigidity of the strip-shaped element is increased toward both sides in the axial direction of the tubular main body of the pressurizing device.

8. A method for manufacturing the fiber-reinforced resin pipe using the pressurizing device according to claim 1, which comprises:
a laminating step of laminating the prepreg sheets on a mandrel to form the pipe-shaped laminate body;
a setting step of setting the helical cut portion of the pressurizing device so as to cover the outer peripheral surface of the laminate body; and
a pressurizing step of pressing the pipe-shaped laminate body toward the mandrel by reducing said inner diameter in the helical cut portion.

9. The method according to claim 8, which further comprises a heating step of heating the laminate body while the laminate body is pressed by the helical cut portion.

10. The method according to claim 8, which further comprises, after the laminating step and before the setting step, a step of forming a barrier layer for preventing the laminate body from coming into direct contact with the helical cut portion.

11. A method for manufacturing the fiber-reinforced resin pipe using the pressurizing device according to claim 1, which comprises:
a laminating step of laminating the prepreg sheets on an outer peripheral surface of the helical cut portion of the pressurizing device to form the pipe-shaped laminate body;
a setting step of setting the pipe-shaped laminate body in a cavity of a mold together with the pressurizing device; and
a pressurizing step of pressing the laminate body toward the internal surface of the cavity by increasing said outer diameter in the helical cut portion.

12. The method according to claim 11, which further comprises a heating step of heating the laminate body while the laminate body is pressed by the helical cut portion.

13. The method according to claim 11, which further comprises, before the laminating step, a step of forming a barrier layer for preventing the laminate body from coming into direct contact with the helical cut portion.

14. The method according to claim 10, wherein the barrier layer is a single sheet which is wound in a pipe shape.

15. The method according to claim 13, wherein the barrier layer is a single sheet which is wound in a pipe shape.

16. The method according to claim 10, wherein the barrier layer is a tape helically which is wound a plurality of times.

17. The method according to claim 13, wherein the barrier layer is a tape helically which is wound a plurality of times.

18. The method according to claim 10, wherein the barrier layer is a resin tube.

19. An apparatus for manufacturing the fiber-reinforced resin pipe, which comprises: a mandrel; and the pressurizing device according to claim 1 for pressing the pipe-shaped laminate body formed on the mandrel toward the mandrel.

20. An apparatus for manufacturing the fiber reinforced resin pipe, which comprises: the pressurizing device according to claim 1; and a mold for shaping the laminate body formed on the pressurizing device.
